(19) United States
(12) Patent Application Publication
(10) Pub. No.: US 2008/0049044 A1
(43) Pub. Date: Feb. 28, 2008

(54) DISPLAY SYSTEM AND DISPLAY METHOD

(75) Inventor: Takashi NITTA, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/762,594

(22) Filed: Jun. 13, 2007

(30) Foreign Application Priority Data
Jun. 19, 2006 (JP) 2006-168398
Jun. 11, 2007 (JP) 2007-153640

(51) Int. Cl. G09G 5/00

(52) U.S. Cl. 345/634

(57) ABSTRACT

[Problem] To provide a display system and a display method that are capable of displaying, with a simple structure, a high-quality image with a remarkably improve contrast.

[Means for Resolution] A display system 2 includes a display object 14 having a first image 12 formed thereon, an image display unit (a projection display unit 26 of a projector 18) that displays a second image 16, which includes an area having a gradation state substantially identical with an area of at least a part of the first image 12, to the display object 14, and an image-area positioning unit (a projection-area positioning unit 28 of the projector 18) for superimposing the areas having the substantially identical gradation states of the first image 12 and the second image 16 each other.

### TECHNICAL FIELD

The present invention relates to a display system and a display method.

### BACKGROUND ART

In recent years, there has been remarkable improvement in image qualities in electronic display devices such as an LCD, an EL, a plasma display, a CRT, and a projection-type display device (a projector). In particular, concerning resolution, a device having performance substantially equivalent to the human visual characteristic is being realized. However, as to a luminance dynamic range, a reproduction range thereof is limited to a range of about several thousands to one in a darkroom contrast ratio. Under a bright room environment, the reproduction range is about several hundreds to one.

On the other hand, concerning the human visual sense, it is said that a range of a luminance dynamic range that can be sensed at a time is several thousands to one to several tens thousand to one in a contrast ratio and a luminance discrimination ability (contrast resolution: ability that can discriminate light and shade of luminance) is 0.2 [nit] (luminance: luminance represents light intensity per a unit area of a light source that emits light and is an amount concerning a light source. A unit of luminance is nit=cd/m²). This is equivalent to 12 bit in terms of a gradation.

When a displayed image of a present electronic display device is viewed through such a visual characteristic, narrowness of the luminance dynamic range is conspicuous and, in addition, gradations in a shadow portion and a highlight portion are insufficient. Thus, a user feels dissatisfaction about reality and dynamism of the displayed image.

To cope with such a problem, various techniques for pursuing reality of rendering while maintaining performance of an electronic display device have been disclosed. For example, there is proposed a technique for enhancing display of a perspective by detecting an image of the perspective and modulating, according to a result of the detection, visible light for illuminating the perspective (see, for example, Patent Document 1).

There is also proposed a method of improving, by projecting an image of an object on the object, a contrast of a bright portion and a dark portion of the object and an apparatus for the method (see, for example, Patent Document 2).

[Patent Document] JP-A-3-226712

[Patent Document] JP-T-2001-522544

### DISCLOSURE OF THE INVENTION

### Problems that the Invention is to Solve

However, in the two proposals, imaging means (an image detector) such as a video camera is essential in order to detect the image of the perspective and acquire an image that should be projected. Thus, there is a problem in that an apparatus (a system) necessary in performing display tends to be complicated, large in size, and high in cost. Further, in the two proposals, it is necessary to perform positioning of the projection objects (the perspective and the object) and images projected (illuminated) on these projection objects (projected images). However, since the projected images are images obtained by imaging the projection objects, there is also a problem in that deviation tends to occur between the projection objects and the projected images because of distortion (e.g., aberration) due to an imaging lens and an imaging system per se.

The present invention has been devised in view of such problems in the past and it is an object of the present invention to provide a display system and a display method that are capable of displaying, with a simple structure, a high-quality image with a remarkably improve contrast.

### Means for solving the Problems

A display system according to the present invention is characterized by including a display object having a first image based on image information formed thereon, an image display unit that displays a second image, which is generated on the basis of image information and includes an area having a gradation state substantially identical with that of an area of at least a part of the first image, to the display object, and an image-area positioning unit for superimposing the areas having the substantially identical gradation states of the first image and the second image on each other.

According to this display system, the display system includes the image display unit that displays the second image, which includes the area having a gradation state substantially identical with that of the area of at least a part of the first image, to the display object having the first image formed thereon and the image-area positioning unit for superimposing the areas having the substantially identical gradation states on each other. Thus, since a bright portion and a bright portion and a dark portion and a dark portion of the respective areas overlap each other, respectively, it is possible to enhance the gradation states (light and shade). As a result, compared with a case in which only the first image is displayed and a case in which only the second image is displayed, it is possible to display an image with a high contrast ratio. Since both the first image and the second image are images based on image information, it is possible to easily correct, by processing image information, distortion that could occur in a process of performing formation and display of the respective images. In other words, it is easy to prevent deviation in superimposing the two images on each other.

In this display system, it is desirable that the area of the first image and the area of the second image have substantially identical coloring states.

According to this display system, since the areas having the substantially identical coloring states overlap each other, it is possible to enhance colors of the respective areas. As a result, compared with a case in which only the first image is displayed and a case in which only the second image is displayed, it is possible to represent colors with high chromas and it is possible to perform color reproduction by a wide color gamut.

This display system may further include an image forming unit that forms the first image on the display object.

According to this display system, since the display system further includes the image forming unit that forms the first image on the display object, it is possible to quickly acquire the display object having the first image formed thereon.

In this display system, it is desirable that the first image and the second image are generated on the basis of common basic image information.

According to this display system, the two images (the first image and the second image) that should be superimposed on each other are generated on the basis of the common image information (basic image information). Thus, compared with a case in which the two images are based on different kinds of image information, it is possible to prevent deviation in superimposing the two images on each other.

In this display system, the second image may be generated on the basis of the basic image information and image information different from the basic image information.

According to this display system, since the second image is generated on the basis of, in addition to the basic image information, the image information different from the basic image information, it is possible to add an image not included in the first image to the first image by displaying this second image.

In this display system, it is desirable that the second image is displayed on a surface having the first image of the display object formed thereon.

According to this display system, the second image is displayed on the surface having the first image formed thereon. In other words, since there is no difference between depths of the first image and the second image, it is possible to prevent the first image and the second image from being seen deviating from each other depending on an angle of viewing the images.

In this display system, it is desirable that the image display unit projects the second image to the display object.

According to this system, since the image display unit displays the second image by projecting the same, it is possible to displays the second image from a position apart from the display object. Therefore, since a viewer is not aware of the presence of the image display unit, it is possible to show as if the display object itself displays an image having a high contrast ratio.

In this display system, a light-emitting display device may be used to display the second image to the display object.

In this display system, the display object may be a reflection-type, a transmission-type, or a semi-transmission-type sheet.

In this display system, the display object may be a positive film.

A display system according to the present invention is characterized by including a display object having a first image based on image information formed thereon and an image display unit that displays a second image, which is generated on the basis of image information and includes an area having a gradation state substantially identical with that of an area of at least a part of the first image, to the display object such that the areas having the substantially identical gradation states overlap each other.

According to this display system, the display system includes the image display unit that displays the second image, which includes the area having a gradation state substantially identical with that of the area of at least a part of the first image, to the display object having the first image formed thereon such that the areas having the substantially identical gradation states overlap each other. Thus, since a bright portion and a bright portion and a dark portion and a dark portion of the respective areas overlap each other, respectively, it is possible to enhance the gradation states (light and shade). As a result, compared with a case in which only the first image is displayed and a case in which only the second image is displayed, it is possible to display an image with a high contrast ratio. Since both the first image and the second image are images based on image information, it is possible to easily correct, by processing image information, distortion that could occur in a process of performing formation and display of the respective images. In other words, it is easy to prevent deviation in superimposing the two images on each other.

In this display system, it is desirable that the area of the first image and the area of the second image have substantially identical coloring states.

This display system may further include an image forming unit that forms the first image on the display object.

In this display system, it is desirable that the first image and the second image are generated on the basis of common basic image information.

In this display system, the second image may be generated on the basis of the basic image information and image information different from the basic image information.

In this display system, it is desirable that the second image is displayed on a surface having the first image of the display object formed thereon.

In this display system, it is desirable that the image display unit projects the second image to the display object.

In this display system, a light-emitting display device may be used to display the second image to the display object.

In this display system, the display object may be a reflection-type, a transmission-type, or a semi-transmission-type sheet.

In this display system, the display object may be a positive film.

A display system according to the present invention is characterized by including a display object, an image forming unit that forms a first image based on basic image information on the display object, and an image display unit that displays a second image, which is generated on the basis of the basic image information and includes an area having a gradation state substantially identical with that of an area of at least a part of the first image, to the display object such that the areas having the substantially identical gradation states overlap each other.

According to this display system, the display system includes the image display unit that displays the second image, which includes the area having a gradation state substantially identical with that of the area of at least a part of the first image, to the display object having the first image formed thereon such that the areas having the substantially identical gradation states overlap each other. Thus, since a bright portion and a bright portion and a dark portion and a dark portion of the respective areas overlap each other, respectively, it is possible to enhance the gradation states (light and shade). As a result, compared with a case in which only the first image is displayed and a case in which only the second image is displayed, it is possible to display an image with a high contrast ratio. Since both the first image and the second image are images based on the image information, it is possible to easily correct, by processing the image information (basic image information), distortion that could occur in a process of performing formation and display of the respective images. In other words, it is easy to prevent deviation in superimposing the two images on each other. Moreover, the two images (the first image and the second image) that should be superimposed on each other are generated on the basis of the common image information (basic image information). Thus, compared with a case in which the two images are based on different kinds of image information, it is possible to prevent deviation in superimposing the two images on each other.

In this display system, it is desirable that the area of the first image and the area of the second image have substantially identical coloring states.

In this display system, the second image may be generated on the basis of the basic image information and image information different from the basic image information.

In this display system, it is desirable that the second image is displayed on a surface having the first image of the display object formed thereon.

In this display system, it is desirable that the image display unit projects the second image to the display object.

In this display system, a light-emitting display device may be used to display the second image to the display object.

In this display system, the display object may be a reflection-type, a transmission-type, or a semi-transmission-type sheet.

In this display system, the display object may be a positive film.

A display system according to the present invention is characterized by including a display object, an image forming unit that forms a first image on the display object on the basis of image information, and an image display unit that displays a second image, which is generated on the basis of image information and includes an area having a gradation state substantially identical with that of an area of at least a part of the first image, to the display object such that the areas having the substantially identical gradation states overlap each other.

According to this display system, the display system includes the image display unit that displays the second image, which includes the area having a gradation state substantially identical with that of the area of at least a part of the first image, to the display object having the first image formed thereon such that the areas having the substantially identical gradation states overlap each other. Thus, since a bright portion and a bright portion and a dark portion and a dark portion of the respective areas overlap each other, respectively, it is possible to enhance the gradation states (light and shade). As a result, compared with a case in which only the first image is displayed and a case in which only the second image is displayed, it is possible to display an image with a high contrast ratio. Since both the first image and the second image are images based on image information, it is possible to easily correct, by processing image information, distortion that could occur in a process of performing formation and display of the respective images. In other words, it is easy to prevent deviation in superimposing the two images on each other.

In this display system, it is desirable that the area of the first image and the area of the second image have substantially identical coloring states.

In this display system, it is desirable that the first image and the second image are generated on the basis of common basic image information.

In this display system, the second image may be generated on the basis of the basic image information and image information different from the basic image information.

In this display system, it is desirable that the second image is displayed on a surface having the first image of the display object formed thereon.

In this display system, it is desirable that the image display unit projects the second image to the display object.

In this display system, a light-emitting display device may be used to display the second image to the display object.

In this display system, the display object may be a reflection-type, a transmission-type, or a semi-transmission-type sheet.

In this display system, the display object may be a positive film.

A display method according to the present invention is characterized by including a step of displaying a second image, which is generated on the basis of image information and includes an area having a gradation state substantially identical with that of an area of at least a part of the first image, to a display object having a first image based on image information formed thereon and a step of performing positioning to superimpose the areas having the substantially identical gradation states of the first image and the second image on each other.

According to this display method, the display method includes the step of displaying the second image, which includes the area having a gradation state substantially identical with that of the area of at least a part of the first image, to the display object having the first image formed thereon and the step of performing positioning to superimpose the areas having the substantially identical gradation states on each other. Thus, since a bright portion and a bright portion and a dark portion and a dark portion of the respective areas overlap each other, respectively, it is possible to enhance the gradation states (light and shade) . As a result, compared with a case in which only the first image is displayed and a case in which only the second image is displayed, it is possible to display an image with a high contrast ratio. Since both the first image and the second image are images based on image information, it is possible to easily correct, by processing image information, distortion that could occur in a process of performing formation and display of the respective images. In other words, it is easy to prevent deviation in superimposing the two images on each other.

In this display method, it is desirable that the area of the first image and the area of the second image have substantially identical coloring states.

This display method may further include a step of forming the first image on the display object.

In this display method, it is desirable that the first image and the second image are generated on the basis of common basic image information.

In this display method, the second image may be generated on the basis of the basic image information and image information different from the basic image information.

In this display method, it is desirable that the second image is displayed on a surface having the first image of the display object formed thereon.

In this display method, it is desirable that, in the step of displaying the second image, the second image is projected to the display object.

In this display method, a light-emitting display device may be used to display the second image to the display object.

In this display method, the display object may be a reflection-type, a transmission-type, or a semi-transmission-type sheet.

In this display method, the display object may be a positive film.

A display method according to the present invention is characterized by including displaying a second image, which is generated on the basis of image information and includes an area having a gradation state substantially identical with that of an area of at least a part of the first image, to a display object having a first image based on image information formed thereon such that the areas having the substantially identical gradation states overlap each other.

According to this display method, the second image that includes the area having a gradation state substantially identical with that of the area of at least a part of the first image is displayed to the display object having the first image formed thereon such that the areas having the substantially identical gradation states overlap each other. Thus, since a bright portion and a bright portion and a dark portion and a dark portion of the respective areas overlap each other, respectively, it is possible to enhance the gradation states (light and shade). As a result, compared with a case in which only the first image is displayed and a case in which only the second image is displayed, it is possible to display an image with a high contrast ratio. Since both the first image and the second image are images based on image information, it is possible to easily correct, by processing image information, distortion that could occur in a process of performing formation and display of the respective images. In other words, it is easy to prevent deviation in superimposing the two images on each other.

In this display method, it is desirable that the area of the first image and the area of the second image have substantially identical coloring states.

This display method may further include a step of forming the first image on the display object.

In this display method, it is desirable that the first image and the second image are generated on the basis of common basic image information.

In this display method, the second image may be generated on the basis of the basic image information and image information different from the basic image information.

In this display method, it is desirable that the second image is displayed on a surface having the first image of the display object formed thereon.

In this display method, it is desirable that, in displaying the second image, the second image is projected to the display object.

In this display method, a light-emitting display device may be used to display the second image to the display object.

In this display method, the display object may be a reflection-type, a transmission-type, or a semi-transmission-type sheet.

In this display method, the display object may be a positive film.

A display method according to the present invention is characterized by including a step of forming a first image based on basic image information on a display object and a step of displaying a second image, which is generated on the basis of the basic image information and includes an area having a gradation state substantially identical with that of an area of at least a part of the first image, to the display object such that the areas having the substantially identical gradation states overlap each other.

According to this display method, the second image that includes the area having a gradation state substantially identical with that of the area of at least a part of the first image is displayed to the display object having the first image formed thereon such that the areas having the substantially identical gradation states overlap each other. Thus, since a bright portion and a bright portion and a dark portion and a dark portion of the respective areas overlap each other, respectively, it is possible to enhance the gradation states (light and shade). As a result, compared with a case in which only the first image is displayed and a case in which only the second image is displayed, it is possible to display an image with a high contrast ratio. Since both the first image and the second image are images based on the image information (basic image information), it is possible to easily correct, by processing the image information, distortion that could occur in a process of performing formation and display of the respective images. In other words, it is easy to prevent deviation in superimposing the two images on each other. Moreover, the two images (the first image and the second image) that should be superimposed on each other are generated on the basis of the common image information (basic image information). Thus, compared with a case in which the two images are based on different kinds of image information, it is possible to prevent deviation in superimposing the two images on each other.

In this display method, it is desirable that the area of the first image and the area of the second image have substantially identical coloring states.

In this display method, the second image may be generated on the basis of the basic image information and image information different from the basic image information.

In this display method, it is desirable that the second image is displayed on a surface having the first image of the display object formed thereon.

In this display method, it is desirable that, in the step of displaying the second image, the second image is projected to the display object.

In this display method, a light-emitting display device may be used to display the second image to the display object.

In this display method, the display object may be a reflection-type, a transmission-type, or a semi-transmission-type sheet.

In this display method, the display object may be a positive film.

A display method according to the present invention is characterized by including a step of forming a first image on a display object on the basis of image information and a step of displaying a second image, which is generated on the basis of image information and includes an area having a gradation state substantially identical with that of an area of at least a part of the first image, to the display object such that the areas having the substantially identical gradation states overlap each other.

According to this display method, the display system includes the image display unit that displays the second image, which includes the area having a gradation state substantially identical with that of the area of at least a part of the first image, to the display object having the first image formed thereon such that the areas having the substantially identical gradation states overlap each other. Thus, since a bright portion and a bright portion and a dark portion and a dark portion of the respective areas overlap each other, respectively, it is possible to enhance the gradation states (light and shade). As a result, compared with a case in which only the first image is displayed and a case in which only the second image is displayed, it is possible to display an image with a high contrast ratio. Since both the first image and the second image are images based on image information, it is possible to easily correct, by processing image information, distortion that could occur in a process of performing formation and display of the respective images. In other words, it is easy to prevent deviation in superimposing the two images on each other.

In this display method, it is desirable that the area of the first image and the area of the second image have substantially identical coloring states.

In this display method, it is desirable that the first image and the second image are generated on the basis of common basic image information.

In this display method, the second image may be generated on the basis of the basic image information and image information different from the basic image information.

In this display method, it is desirable that the second image is displayed on a surface having the first image of the display object formed thereon.

In this display method, it is desirable that, in the step of displaying the second image, the second image is projected to the display object.

In this display method, a light-emitting display device may be used to display the second image to the display object.

In this display method, the display object may be a reflection-type, a transmission-type, or a semi-transmission-type sheet.

In this display method, the display object may be a positive film.

### BEST MODE FOR CARRYING OUT THE INVENTION

Embodiments will be hereinafter explained with reference to the drawings.

### FIRST EMBODIMENT

This embodiment is an example in which a projector is used in a display system. To facilitate understanding of a display (projection) method, first, the display system including the projector will be explained.

FIG. 1 is a block diagram showing a display system according to the first embodiment. As shown in FIG. 1, a display system 2 according to this embodiment includes a display object 14 having a first image 12 formed thereon and a projector 18 that projects a second image 16 to the first image 12 of the display object 14.

The display object 14 is, for example, a photograph sheet for printing a photograph image thereon with an ink-jet printing apparatus or the like. On a surface of the display object 14, the first image 12 generated on the basis of basic image information (basic image data) 30 is printed (formed). The basic image information 30 is, in this embodiment, image information representing a photograph image photographed by a digital still camera of a single lens reflex type. However, the basic image information 30 is not limited to this and may be, for example, image information based on a film or a photograph scanned by an image scanner and image information representing an image artificially created like CG (Computer Graphics). The display object 14 is not limited to the above as long as the first image 12 can be formed thereon.

The projector 18 includes a projector image information I/F (interface) 22, a projector image converting/image processing unit 24, a projection display unit 26 as an image display unit, and a projection-area positioning unit 28 as an image-area positioning unit.

The projector image information I/F 22 inputs the basic image information 30, i.e., image information forming a basis of the first image 12.

The projector image converting/image processing unit 24 applies, according to performance of the projection display unit 26, processing such as scaling, color conversion, gamma correction, image correction, processing for modulating colors, chroma enhancement, contrast enhancement processing, and mirror image reversal processing to the basic image information 30 inputted from the projector image information I/F 22 and generates second image information 32.

The projection display unit 26 includes a light source, a display element having a modulation element such as a liquid crystal panel, and a projection optical system (all of which are not shown in the figure). The projection display unit 26 modulates light emitted from the light source with the display element and generates the second image 16 on the basis of the second image information 32 generated by the projector image converting/image processing unit 24. Then, the projection display unit 26 enlargedly projects the generated second image 16 to the display object 14 having the first image 12 formed thereon from the projection optical system. The modulation element is not limited to the liquid crystal panel. It is also possible to use a display device that controls an emission direction of light emitted from the light source for each micro-mirror to form an image. Moreover, the projection display unit 26 may include a light source and a scanning unit (both of which are not shown in the figure). In that case, the scanning unit generates the second image 16 by scanning light from the light source and projects the second image 16 to the display object 14 having the first image 12 formed thereon.

Both the first image 12 and the second image 16 are generated on the basis of common image information (the basic image information 30) and gradation states (distributions of light and shade) and coloring states (distributions of colors) of these two images are substantially identical. However, the coloring states do not always have to be substantially identical. One of the images may be a monochrome image and the other image may be a color image. Ranges in which the gradation states and the coloring states are substantially identical do not always have to be entire areas of the images. The second image 16 only has to include an area having a gradation state and a coloring state substantially identical with those in an area of at least a part of the first image 12 (this will be described in detail later).

In this specification, “gradation states of two images (areas) are substantially identical” means that distributions of relative brightness in the respective images (areas) are substantially equal. The two images (areas) may have a difference in resolution, a difference in sharpness, a difference in an amount of noise contained, or a difference in presence or absence of colors (a color image and a monochrome image). Further, “coloring states of two images (areas) are substantially identical” means that colors in use and distributions of the colors are substantially equal in the respective images (areas) and that regions corresponding to each other in a positional relation have an identical color or colors of a similar shade. The colors of a similar shape can be defined that, for example, when colors of two regions corresponding to each other in a positional relation are represented using an HSV color space, a value of a hue of one region (0° to 360°) is within ±10% of a value of a hue of the other, i.e., within ±36°.

The projection-area positioning unit 28 performs positioning of a projection area of the second image 16 according to a position of the first image 12 in order to display a combined image 34 obtained by superimposing the second image 16 on the first image 12. Positioning means superimposing the two images (the first image 12 and the second image 16) having the substantially identical gradation states without deviation and includes adjusting a size of the second image 16 according to a seize of the first image 12 and adjusting a position (a projecting direction) of the second image 16 according to the position of the first image 12. When the projector 18 performs projection without being right opposed to the first image 12 (the display object 14), distortion (trapezoidal distortion) occurs in the second image 16 and the second image 16 cannot be superimposed on the first image 12 without deviation. Thus, correcting the second image 16 to an original state without distortion is also included in the positioning. When the ranges in which the gradation states are substantially identical are not the entire areas of the images but are a part of the areas, it is necessary to perform positioning such that these areas overlap each other (this will be described in detail later).

The projector 18 has, for example, a memory card slot as the projector image information I/F 22 and can read the basic image information 30 stored in the memory card. The projector image converting/image processing unit 24 applies scaling processing for adjusting the number of pixels to the number of pixels of the display element of the projection display unit 26 to the basic image information 30 read and generates the second image information 32. For example, when the projection display unit 26 includes a display element having the number of pixels of 1024×768 and the basic image information 30 has the number of pixels of horizontal 2800 pixels and vertical 2100 pixels, the projector image converting/image processing unit 24 reduces the basic image information 30 to about 1/2.7 and generates the second image information 32. Since it is necessary to adjust colors according to characteristics of the light source and the display element of the projector 18, the projector image converting/image processing unit 24 has an LUT (a color table) (not shown) that reflects the characteristics and also performs processing for converting colors using this LUT. The projector image converting/image processing unit 24 may perform correction processing for correcting distortion of the second image 16 due to aberration or the like of the projection optical system, chroma enhancement or contrast enhancement processing for improving attractiveness of the image itself, and the like. The projector image information I/F 22 is not limited to a memory card slot and may be other storage devices such as a USB memory and various communication I/Fs such as a wireless LAN.

As described above, the projector 18 is capable of performing positioning of a projection area of the second image 16 with the projection-area positioning unit 28 in order to display the combined image 34 of the first image 12 and the second image 16. As a positioning method for a projection area, for example, as described in JP-A-2002-44571, a user can adjust positions of four corners of a projection area to desired positions using a pointing device or the like included in a remote controller or the like.

The positioning is not limited to the method described above. For example, in order to adjust a size of the second image 16, it is possible to adjust a distance between the projector 18 and the display object 14, adjust a display magnification using an optical zoom mechanism (not shown) included in the projection display unit 26, and adjust a size of an image formed on the display element using the projector image converting/image processing unit 24. In order to adjust a position of the second image 16, it is possible to change a position where the projector 18 is set, expanding and contracting a stretchable leg portion (not shown) provided on a bottom surface of the projector 18 to adjust a vertical direction of the projector 18, use a lens shift mechanism for adjusting upper, lower, left, and right display positions by shifting a position of a projection lens provided on an output side of the projection display unit 26, and adjust a position of an image formed on the display element using the projector image converting/image processing unit 24. Moreover, when the projector 18 performs projection without being right opposed to the first image 12 (the display object 14), it is possible to cause the projector image converting/image processing unit 24 to perform correction processing in order to correct trapezoidal distortion. The user is capable of appropriately combining the methods described above to perform positioning of the first image 12 and the second image 16. In this case, all of the zoom mechanism, the projector image converting/image processing unit 24, the leg portion, the lens shift mechanism, and the like described above function as the projection-area positioning unit 28.

FIGS. 2 to 5 are explanatory diagrams for explaining specific examples of positioning. In the respective figures, (a) is a diagram showing the first image 12, (b) is a diagram showing the second image 16, and (c) is a diagram showing the combined image 34 of the first image 12 and the second image 16. In the respective figures, the second image 16 in (b) is shown in a size subjected to size adjustment.

As in the examples shown in FIGS. 2(a) to 2(c), when both the first image 12 and the second image 16 are generated on the basis of the basic image information 30 and are substantially identical images over the entire areas thereof, i.e., when gradation states of the two images 12 and 16 are substantially identical over the entire areas of the images, positioning is performed such that the entire first image 12 and the entire second image 16 overlap each other.

In the examples shown in FIGS. 3(a) to 3(c), the first image 12 is an image based on the basic image information 30 and the second image 16 is an image obtained by extracting an area (an area 12a) of a part of the first image 12. In other words, both the images are generated on the basis of at least a part of the basic image information 30.

As shown in FIGS. 3(a) to 3(c), when the second image 16 is substantially identical with the area 12a of a part of the first image 12, i.e., when a gradation state of the second image 16 is substantially identical with a gradation state of the area 12a of the first image 12, positioning is performed such that the second image 16 and the area 12a of the first image 12 overlap each other.

In the examples shown in FIGS. 4(a) to 4(c), the first image 12 is an image based on the basic image information 30 and the second image 16 is an image including an area (an area 16a) in which the first image 12 is copied. In other words, both the images are generated on the basis of at least a part of the basic image information 30.

As shown in FIGS. 4(a) to 4(c), when the area 16a of the second image 16 is substantially identical with the first image 12, i.e., when a gradation state of the area 16a of the second image 16 is substantially identical with a gradation state of the first image 12, positioning is performed such that the first image 12 and the area 16a of the second image 16 overlap each other.

In the examples in FIGS. 5(a) to 5(c), the first image 12 is an image based on the basic image information 30 and the second image 16 is an image having, on a black plain background, an area 16b in which an area (an area 12b representing an apple) of a part of the first image 12 is copied. In other words, both the images are generated on the basis of at least a part of the basic image information 30.

As shown in FIGS. 5(a) to 5(c), when the second image 16 includes the area (an area representing an apple) 16b having a gradation state substantially identical with that of the area (the area 12b representing an apple) of a part of the first image 12, positioning is performed such that the area 12b of the first image 12 and the area 16b of the second image 16 overlap each other.

It is possible to represent pitch dark by performing this positioning to superimpose a dark area (pixels) of the first image 12 and a dark area (pixels) of the second image 16 on each other. It is possible to represent brightness by performing this positioning to superimpose a bright area (pixels) of the first image 12 and a bright area (pixels) of the second image 16 on each other. In other words, only faint light is irradiated on an area with a low light reflectance (a dark area) of the first image 12 and more light is irradiated on an area with a higher light reflectance (a brighter area) of the first image 12. Thus, gradation states (light and shade) of the two images 12 and 16 enhance each other and a contrast of the combined image 34 is improved. A contrast ratio of the combined image 34 is obtained by multiplying contrast ratios of the respective images 12 and 16 each other. Therefore, for example, when the first image 12 of the display object 14 has a contrast ratio of 200:1 and the second image 16 of the projector 18 has a contrast ratio of 1000:1, the combined image 34 has a contrast ratio of 200×1000=200000:1 in a dark room environment. Thus, it is possible to realize high-quality display with a remarkably improved contrast. Since a sense of resolution of the combined image 34 depends on a resolution of one image (an image having a higher resolution) of the first image 12 and the second image 16, a resolution of the other image may be set low. With such a constitution, it is possible to reduce cost of a section where an image with a low resolution is generated.

In this embodiment, high contrast performance can be shown even in a bright room environment. In a normal display device, a state called floating black in which black is displayed extremely bright because a screen surface of the display device defines black and the screen surface is brightened under the bright room environment. On the other hand, in this embodiment, it is possible to represent black using black of an ink printed on the display object 14. Since a black ink absorbs a large percentage of light compared with the screen surface even under the bright room environment, it is possible to represent solid black.

Since white of printing is white generated by reflection, it is extremely difficult to represent feeling of shining of a light emitting object. This is because, since a human senses intensity of lighting in an environment in which the human is present and a reflectance of a reflection object, the human does not recognize the reflection object as a light emitting object unless luminance exceeds a reflectance of paper under the lighting in the environment. However, in this embodiment, since it is possible to irradiate a large amount of light on an area representing light emission, it is possible to generate luminance exceeding the reflectance of paper under the lighting and represent the light emitting object. In other words, it is possible to represent both pitch dark and brightness.

A hardware configuration constituting the display system 2 is not limited to this example. For example, a PC (personal computer) may perform all the kinds of processing performed by the projector image converting/image processing unit 24.

The display system 2 according to this embodiment is constituted as described above. A display method of the display system 2 will be hereinafter explained.

FIG. 6 is a flowchart showing a display method according to the first embodiment. First, as shown in FIG. 6, the display object 14 having the first image 12 formed thereon is prepared (step S100).

The display system 2 reads the basic image information 30 through the projector image information I/F 22 of the projector 18 (step S110).

The display system 2 applies, in the projector image converting/image processing unit 24, scaling, color conversion, gamma correction, image correction, and the like adjusted to performance of the projection display unit 26 to the basic image information 30 and generates the second image information 32 (step S120).

The display system 2 projects, in the projection display unit 26 of the projector 18, the second image 16 generated on the basis of the second image information 32 to the first image 12 on the display object 14 and displays the second image 16 on the display object 14 (step S130).

The display system 2 performs, in the projection-area positioning unit 28 of the projector 18, positioning of a projection area of the second image 16 such that the second image 16 overlap the first image 12 (step S140). According to this positioning, a dark area (pixels) of the first image 12 and a dark area (pixels) of the second image 16 overlap each other and pitch black is represented. A bright area (pixels) of the first image 12 and a bright area (pixels) of the second image 16 overlap each other and brightness is represented. In other words, gradation states of the respective images are enhanced.

Structures of the first image 12 and the second image 16 will be explained.

FIG. 7 is a diagram showing structures of a first image and a second image according to the first embodiment. As shown in FIG. 7, in this embodiment, the second image 16 is displayed on a surface 38 identical with a surface 36 of the display object 14 having the first image 12 formed thereon. In this case, it is possible to view, from an eye point 40, the combined image 34 having an extremely high contrast obtained by combining the second image 16 with the first image 12 formed on the display object 14 as in the above explanation.

In this embodiment, since a photograph sheet, i.e., a reflection-type (diffusion-type) display object 14, is used as the display object 14, the combined image 34 is viewed from the eye point 40. However, if a semi-transmission-type display object 14 having a diffusion property is used or a transmission-type display object 14 is used together with a not-shown diffusion plate, it is also possible to view the combined image 34 from an eye point 42. In an image viewed from the eye point 40 and an image viewed from the eye point 42, the left and the right are reversed. Thus, when the transmission-type or the semi-transmission-type display object 14 is used, the projector image converting/image processing unit 24 also needs to perform processing for mirror-inverting an image generated when the reflection-type display object 14 is used.

Improvement of a contrast of the combined image 34 will be explained.

FIGS. 8 to 11 are diagrams showing the first image, the second image, and a combined image of the first image and the second image according to the first embodiment. In FIGS. 8 to 11, the first image 12 formed on the display object 14, the second image 16 displayed to the first image 12 on the display object 14, and the combined image 34 of the first image 12 and the second image 16 on the surface 36 of the display object 14 having the first image 12 formed thereon are shown.

In an example shown in FIG. 8, the first image 12 is a color image (in the figure, the color image is indicated by monochrome; the same applies in the following explanation) and an image having a contrast ratio of 200:1 (in the figure, the image is indicated by a difference in light and shade; the same applied in the following explanation) printed by an ink-jet printing apparatus. The second image 16 is also a color image and is an image having a contrast ratio of 1000:1 projected from the projector 18. When the first and second images 12 and 16 are combined, a contrast ratio of the combined image 34 (color) is 200×1000=200000:1.

In an example shown in FIG. 9, the first image 12 is a monochrome image and is an image having a contrast ratio of 200:1 printed by the ink-jet printing apparatus. The second image 16 is a color image and is an image having a contrast ratio of 1000:1 projected from the projector 18. When the first and second images 12 and 16 are combined, the combined image 34 is a color image and a contrast ratio of the combined image 34 is 200×1000=200000:1. In this way, in this embodiment, when one image is monochrome, it is possible to realize both addition of colors and improvement of a contrast.

In an example shown in FIG. 10, the first image 12 is a monochrome image and is an image having a contrast ratio of 200:1 printed by the ink-jet printing apparatus. The second image 16 is a color image and is an image having a contrast ratio of 1000:1 generated and projected by the projector 18 based on information of a part of the basic image information 30 (information indicating a lower part of an image). When the first and second images 12 and 16 are combined, the combined image 34 includes the monochrome image (an upper part) and the color image (a lower part). A contrast ratio of the combined image 34 is 200×1000=200000:1 only in a part (the lower part). In this way, in this embodiment, it is also possible to display only a part of an image with an extremely high quality (high contrast). For example, it is possible to enhance, by displaying only commodities with an extremely high quality in advertisement display, the commodities through comparison with images around the commodities and improve an advertisement effect.

In an example shown in FIG. 11, the first image 12 is a color image and is an image having a contrast ratio of 200:1 printed using information of a part of the basic image information 30 (information indicating a lower part of an image) in the ink-jet printing apparatus. The second image 16 is a color image and is an image having a contrast ratio of 1000:1 projected from the projector 18. When the first and second images 12 and 16 are combined, a contrast ratio of the combined image 34 (color) is 200×1000=200000:1 only in a part (the lower part). In this way, in this embodiment, it is also possible to display only a part of an image with an extremely high image quality (high contrast). For example, it is possible to enhance, by displaying only commodities with an extremely high quality in advertisement display, the commodities through comparison with images around the commodities and improve an advertisement effect. In this example, since a background is added by the second image 16 in an upper part of the first image 12, it is possible to increase a change due to the combination and perform display that attracts attention.

In other words, the examples shown in FIGS. 8 to 11 indicate that a contrast of the combined image 34 of the first image 12 and the second image 16 is improved to be higher than contrasts of the first and second images 12 and 16.

In this embodiment, the first image 12 formed by printing, i.e., the first image 12 represented by subtractive color mixture, and the second image 16 projected from the projector 18, i.e., the second image 16 represented by additive color mixture, are combined. When a color is represented by the additive color mixture, in particular, for example, when the liquid crystal projector is used as in this embodiment, a color gamut in a portion that is bright in terms of brightness is wide and, on the other hand, a color gamut is narrowed because of an influence of light leakage or the like in a portion that is dark in terms of brightness. On the contrary, when a color is represented by the additive color mixture, a color gamut in a portion that is dark in terms of brightness is wide and, on the other hand, a color gamut in a portion that is bright in terms of brightness is narrow. Therefore, it is possible to cause the respective color gamuts to complement each other by combining the color gamuts and it is possible to perform color representation by a wider color gamut.

Extension of a color gamut of the combined image 34 will be explained using FIGS. 12 to 16.

FIG. 12 is a graph showing a spectral reflectance of paper. In the figure, a curve Pw indicates a spectral reflectance of white paper, a curve Pg indicates a spectral reflectance of a region to which green printing is applied on the white paper (hereinafter referred to as green portion), a curve Pb indicates a spectral reflectance of a region to which blue printing is applied on the white paper (hereinafter referred to as blue portion), and a curve Pr indicates a spectral reflectance of a region to which red printing is applied on the white paper (hereinafter referred to as red portion).

FIGS. 13 to 15 are graphs showing spectral characteristics of projected lights projected from the projector 18. In FIG. 13, a curve Go indicates a spectral waveform of green light projected from the projector 18, a curve Gw indicates a spectral waveform in the case in which this green light is reflected on the white paper, and a curve Gg indicates a spectral waveform in the case in which the green light is reflected on the green portion. A curve Bo in FIG. 14 indicates a spectral waveform of blue light projected from the projector 18, a curve Bw indicates a spectral waveform in the case in which this blue light is reflected on the white paper, and a curve Bb indicates a spectral waveform in the case in which the blue light is reflected on the blue portion. A curve Ro in FIG. 15 indicates a spectral waveform of red light projected from the projector 18, a curve Rw indicates a spectral waveform in the case in which this red light is reflected on the white paper, and a curve Rr indicates a spectral waveform in the case in which the red light is reflected on the red portion. All the curves are drawn on the basis of experimental data.

As shown in FIG. 13, when the green light (the curve Go) projected from the projector 18 is reflected on the white paper showing a substantially flat reflectance in a visible light region (see the curve Pw in FIG. 12), as indicated by the curve Gw, reflected light of the green light has a spectral characteristic substantially identical with the projected light (the green light) indicated by the curve Go. On the other hand, when the green light (the curve Go) projected from the projector 18 is reflected on the green portion showing a reflectance that is high with respect to only light (the green light) in a specific wavelength region (see the curve Pg in FIG. 12), reflected light of the green light has a spectral characteristic indicated by the curve Gg. Compared with the curves Go and Gw, a wavelength region of light contained is narrowed and green light having a high chroma is obtained. In the same manner, for the other color lights (the red light and the blue light), it is possible to improve a chroma by reflecting the color lights on regions to which printing of substantially identical colors is applied (see FIGS. 14 and 15).

FIG. 16 is an xy chromaticity diagram for explaining a color gamut. A curve M in the figure is a locus of single color light having a highest chroma. A region Aw is a color gamut in the case in which projected light from the projector 18 is reflected on the white paper. A region Ap is a color gamut in the case in which the projected light from the projector 18 is reflected on a region to which printing of a substantially identical color is applied.

As shown in FIG. 16, when the projected light from the projector 18 is reflected on the region to which the printing of a substantially identical color is applied, i.e., coloring states of the first image 12 and the second image 16 are substantially identical and the first image 12 and the second image 16 are positioned, compared with the case in which the projected light is reflected on the white paper, since chromas of the respective colors are improved, it is possible to widen the color gamuts.

As explained above, according to the display system 2 according to this embodiment, it is possible to obtain the following effects.

(1) According to this embodiment, the projector 18 projects the second image 16 including an area having a gradation state substantially identical with an area of at least a part of the first image 12 to the display object 14 having the first image 12 formed thereon and includes the projection-area positioning unit 28 for superimposing the areas having the substantially identical gradation states. Thus, since a bright portion and a bright portion and a dark portion and a dark portion of the respective areas overlap each other, respectively, it is possible to enhance the gradation states (light and shade). As a result, compared with a case in which only the first image 12 is displayed and a case in which only the second image 16 is displayed, it is possible to display the combined image 34 with a high contrast ratio. For example, it is also possible to improve a contrast ratio in a dark room to several hundreds thousand to one and improve a contrast ratio in a bright room to several thousands to one. According to this display system 2, since it is unnecessary to provide imaging means such as a video camera, it is possible to realize improvement of a contrast with an extremely simple structure.

(2) According to this embodiment, since both the first image 12 and the second image 16 are images based on image information, it is possible to easily correct, by processing image information, distortion that could occur in a process of performing formation and display of the respective images. In other words, it is easy to prevent deviation in superimposing the two images on each other.

(3) According to this embodiment, it is possible to enhance the colors of the respective regions each other by superimposing the regions having the substantially identical coloring states each other. As a result, compared with a case in which only the first image 12 is displayed and a case in which only the second image 16 is displayed, it is possible to display an image with a high chroma and it is possible to perform color reproduction with a wide color gamut. According to this embodiment, since the first image 12 is formed by printing (the subtractive color mixture) and the second image 16 is formed by projection from the projector 18 (the additive color mixture), it is possible to cause color gamuts of the respective images to complement each other by combining the images and it is possible to perform color reproduction with a wide color gamut.

(4) According to this embodiment, the two images (the first image 12 and the second image 16) that should be superimposed on each other are generated on the basis of the common image information (the basic image information 30). Thus, compared with a case in which the two images are based on different kinds of image information, it is possible to prevent deviation in superimposing the two images on each other. For example, when the second image 16 is formed on the basis of image information obtained by imaging the first image 12, the image information is affected by distortion (e.g., aberration) due to the imaging system or the like. Thus, at a stage when the image information is generated, i.e., before the second image 16 is formed, deviation is latent between the first image 12 and the second image 16. On the other hand, when the two images are based on the common image information, since there is no deviation at a stage before an image is formed, it is possible to prevent deviation in superimposing the two images on each other.

(5) According to this embodiment, the second image 16 is displayed on the surface 36 of the display object 14 having the first image 12 formed thereon. In other words, since there is no difference between depths of the first image 12 and the second image 16, it is possible to prevent the first image 12 and the second image 16 from being seen deviating from each other depending on an angle of viewing the images.

(6) According to this embodiment, since the second image 16 is displayed by projection from the projector 18, it is possible to displays the second image 16 from a position apart from the display object 14. Therefore, since a viewer is not aware of the presence of means for displaying the second image 16 (the projector 18), it is possible to show as if the display object 14 itself displays an image having a high contrast ratio. Since the projector 18 can change a size of a projection area by changing a distance to the display object 14 and using a zoom mechanism or the like, it is easy to adjust a size of the second image 16 to the first image 12 of various sizes.

(7) In this embodiment, if ranges in which gradation states of the first image 12 and the second image 16 are substantially identical are limited to areas of a part of the images, it is possible to make only the areas conspicuous with a high contrast. Therefore, for example, it is possible to enhance, by displaying only commodities with an extremely high quality in advertisement display, the commodities through comparison with images around the commodities and improve an advertisement effect.

(8) In this embodiment, if the first image 12 is set as a monochrome image, the second image 16 is set as a color image, and presence or absence of combination (display of the second image 16) is switched, it is possible to switch the display of the monochrome image and the display of a high contrast color image and give a large change to the display of the images. It is also possible to add colors to only an area in a part of the monochrome image.

(9) According to this embodiment, it is possible to generate the first image 12 using a printer or a printing apparatus for offset printing or the like. Thus, even when the combination with the second image 16 is not performed, it is possible to display the first image 12 with a fixed image quality. Moreover, it is possible to perform extremely high quality display by displaying the second image 16 to be adjusted to the position of the first image 12.

### SECOND EMBODIMENT

FIG. 17 is a block diagram showing a display system according to a second embodiment. A display system 4 according to this embodiment includes, as shown in FIG. 17, a printing apparatus 44 that prints the first image 12, which is generated on the basis of the basic image information 30, on the display object 14.

The printing apparatus 44 includes a printer image information I/F 46, a printer image converting/image processing unit 48, and a printing unit 50. The printing apparatus 44 generates first image information 20 on the basis of the basic image information 30 and prints (forms) the first image 12, which is generated on the basis of the first image information 20, on the display object 14.

The printer image information I/F 46 inputs, as basic image information that should be printed, the basic image information 30 forming a basis of the second image 16.

The printer image converting/image processing unit 48 applies, according to performance of the printing unit 50, processing such as scaling, color conversion, gamma correction, image correction, area coverage modulation processing, processing for converting colors, chroma enhancement, contrast enhancement processing, and mirror image reversal processing to the basic image information 30 inputted and generates the first image information 20.

The printing unit 50 is equivalent to the image forming unit and prints (forms) the first image 12, which is generated on the basis of the first image information 20, on the display object 14.

The printing apparatus 44 according to this embodiment is, for example, a stand-alone (not network-connected) ink-jet printer and has a memory card slot as the printer image information I/F 46. When the printer image information I/F 46 reads the basic image information 30 stored in a memory card, the printer image converting/image processing unit 48 applies scaling processing to the basic image information 30 and generates the first image information 20 having the number of pixels that depends on a size of the first image 12 that should be formed, the number of pixels of the basic image information 30, and a resolution of the printing unit 50. For example, when the size of the first image 12 that should be formed is 280 mm×210 mm, the basic image information 30 has the number of pixels of horizontal 2800 pixels and vertical 2100 pixels, and the printing unit 50 has a resolution of 720 dpi, the number of pixels of the first image information 20 that should be generated is horizontal 7937 pixels and vertical 5952 pixels. Thus, it is necessary to enlarge the basic image information 30 to be about 2.8 as large as the basic image information.

Since an ink-jet printing apparatus adopts binary display indicating whether dots are “formed or not formed”. Thus, in order to represent a full-color image with the two values, the printer image converting/image processing unit 48 performs an area coverage modulation processing called half tone and converts the basic image information 30 to binary information. Moreover, for example, in an ink-jet printer that uses inks of six colors, cyan (C), magenta (M), yellow (Y), black (K), light cyan (Lc), and light magenta (Lm), the basic image information 30 of 24 bits in total per one pixel consisting of 8 bits for each color of R, G, and B is converted into information of 6 bits in total consisting of 1 bit for each color of M, Y, K, Lc, and Lm. In other words, the printer image converting/image processing unit 48 performs conversion from RGB into CMYKLcLm simultaneously with binarization. In that case, since it is necessary to adjust colors according to characteristics of inks and paper, the printer image converting/image processing unit 48 has an LUT (a color table) that reflects the characteristics (not shown) and also performs processing for converting colors using this LUT. The printer image converting/image processing unit 48 may perform correction processing for correcting the first image 12 according to distortion of the second image 16 due to aberration or the like of the projection optical system of the projector 18, chroma enhancement or contrast enhancement processing for improving attractiveness of the image itself, and the like.

The printing apparatus 44 is not limited to the ink-jet printer. It is also possible to use printers of other forms such as a thermal printer like a sublimation-type printer, a laser printer, and the like. The printer image information I/F 46 is not limited to the memory card slot and may be other storage devices such as a USB memory and various communication I/Fs such as a wireless LAN.

A hardware configuration constituting the display system 4 is not limited to this example. A PC (personal computer) may perform all the kinds of processing performed by the printer image converting/image processing unit 48. Concerning other components, it is possible to apply the details explained in the first embodiment.

The display system 4 according to this embodiment is constituted as described above. A display method of the display system 4 will be hereinafter explained.

FIG. 18 is a flowchart showing the display method according to the second embodiment. As shown in FIG. 18, the printing apparatus 44 reads the basic image information 30 through the printer image information I/F 46 (step S200).

The printing apparatus 44 applies, in the printer image converting/image processing unit 48, scaling, color conversion, gamma correction, image correction, and the like adjusted to performance of the printing unit 50 to the basic image information 30 and generates the first image information 20 (step S210).

The printing apparatus 44 prints, in the printing unit 50 of the printing apparatus 44, the first image 12, which is generated on the basis of the first image information 20, on the display object 14 (step S220).

The printing apparatus 44 may perform, when the display object 14 as the printing object is a transmission type or a semi-transmission type, mirror image reversal processing in the printer image converting/image processing unit 48.

According to the processing described above, the first image 12 is formed on the display object 14. When the second image 16 is projected on the display object 14 having the first image 12 formed thereon, it is possible to apply the details explained in the first embodiment.

As explained above, in this embodiment, since the printing apparatus 44 that forms the first image 12 on the display object 14 is provided, it is possible to quickly acquire the display object 14 having the first image 12 formed thereon. Therefore, for example, even when change (replacement), correction, or the like of the basic image information 30 is performed, it is possible to immediately check the high contrast combined image 34.

### THIRD EMBODIMENT

FIG. 19 is a block diagram showing a display system according to a third embodiment. In a display system 6 according to this embodiment, as shown in FIG. 19, the projector 18 generates the second image information 32 on the basis of the basic image information 30 forming a basis of the first image 12 and other image information (third image information 52) different from the basic image information 30, generates the second image 16 on the basis of this second image information 32, and projects the second image 16 to the display object 14.

The third image information 52 may be image information representing a photograph image photographed by a digital still camera of a single lens reflex type or may be image information based on a film or a photograph scanned by an image scanner or image information representing an image artificially created like CG. Moreover, the third image information 52 may be image information representing a moving image photographed by a video camera or the like or a moving image formed by CG. Concerning other components and a display method, it is possible to apply the details explained in the second embodiment.

As explained above, in this embodiment, the second image 16 is generated on the basis of the basic image information 30 and the other image information (the third image information 52) different from the basic image information 30. Thus, the second image 16 includes an image not included in the first image 12. Therefore, it is possible to add the image not included in the first image 12 to the first image 12 by displaying (combining) this second image 16. It is also possible to give a large change to display of an image by switching presence or absence of display (combination) of the second image 16.

### FOURTH EMBODIMENT

FIG. 20 is a diagram showing a display system according to a fourth embodiment. A display system 8 according to this embodiment includes, as shown in FIG. 20, the display object 14 and a light-emitting display device 54 that displays the second image 6 to the first image 12 on the display object 14.

The display object 14 according to this embodiment is formed of a material having translucency. Specifically, it is possible to use a semi-transmission-type display object such as a backlight film or a transmission-type display object such as an OHP (Overhead Projector) sheet or a positive film. When the display object 14 is the backlight film or the OHP sheet, it is possible to form the first image 12 on the display object 14 by using an ink-jet printing apparatus or the like. When the display object 14 is the positive film, an apparatus that can print digital information on a film such as a film recorder only has to be used.

The light-emitting display device 54 is a light-emitting display device such as an LCD (Liquid Crystal Display), a PDP (Plasma Display Panel), an SED (Surface-conduction Electron-emitter Display), or an organic EL (Electro Luminescence) display and is equivalent to the image display unit. The light-emitting display device 54 displays a second image 60 on a display surface 62 thereof.

In a state in which the display object 14 is set in the front of the display surface 62 of the light-emitting display device 54 and positioning is performed such that the first image 12 and the second image 60 overlap each other, when the display object 14 is fixed to the light-emitting display device 54, it is possible to view the extremely high-contrast combined image 34 from an eye point 58. Concerning other components and a display method, it is possible to apply the details explained in the second embodiment. In this embodiment, a not-shown fixing member for fixing the display object 14 to the light-emitting display device 54 is equivalent to the image-area positioning unit. As the fixing member, it is possible to use an adhesive member for sticking the display object 14 to the light-emitting display device 54, a supporting member for supporting the display object 14 and determining a relative position with respect to the light-emitting display device 54, or the like.

As explained above, in this embodiment, by viewing the second image 60 displayed by the light-emitting display device 54 through the translucent display object 14 having the first image 12 formed thereon, it is possible to view an image having a high contrast ratio in which the first image 12 and the second image 60 overlap each other. Since a position, a shape, and a size of a display area of the light-emitting display device 54 are fixed, if the first image 12 adjusted to the display area is formed on the display object 14, it is possible to easily perform positioning of the first image 12 and the second image 60.

### FIFTH EMBODIMENT

FIG. 21 is a diagram showing a display system according to a fifth embodiment. A display system 10 according to this embodiment includes, as shown in FIG. 21, the display object 14 having translucency, the projector 18, a transparent/semitransparent member (a transmission-type screen) 66, and a plate having translucency (a transparent plate 56).

The display object 14 and the transparent/semitransparent member 66 are bonded via the transparent plate 56. The first image 12 is formed on the surface (the surface 36 not bonded with the transparent plate 56) of the display object 14. The second image 16 is projected from the projector 18 set on the surface side and displayed on the surface (the surface 38 not bonded with the transparent plate 56) of the transparent/semitransparent member 66. The second image 16 is positioned on the first image 12. The first image 12 and the second image 16 may be formed (displayed) on the surface bonded with the transparent plate 56.

Consequently, it is possible to view the extremely high-contrast combined image 34 obtained by combining the first image 12 and the second image 16 from an eye point 64. Moreover, the transparent plate 56 has a role of a supporting member for the display object 14 including the surface 36 on which the first image 12 is printed and the transparent/semitransparent member 66 including the surface 38 on which the second image 16 is displayed. Thus, a degree of freedom of display (setting) increases. Concerning other components and a display method, it is possible to apply the details explained in the second embodiment.

It is possible to apply this embodiment to, for example, a sign stand described in JP-A-2005-201964.

The plural embodiments have been explained. However, the present invention is not limited to the embodiments described above and various modifications of the embodiments are possible.

### BRIEF DESCRIPTION OF THE DRAWINGS

FIG. 1 is a block diagram showing a display system according to a first embodiment.

FIG. 2 is an explanatory diagram for explaining a specific example of positioning according to the first embodiment.

FIG. 3 is an explanatory diagram for explaining a specific example of positioning according to the first embodiment.

FIG. 4 is an explanatory diagram for explaining a specific example of positioning according to the first embodiment.

FIG. 5 is an explanatory diagram for explaining a specific example of positioning according to the first embodiment.

FIG. 6 is a flowchart showing a display method according to the first embodiment.

FIG. 7 is a diagram showing structures of first and second images according to the first embodiment.

FIG. 8 is a diagram showing contrasts of the first image, the second image, and a combined image according to the first embodiment.

FIG. 9 is a diagram showing contrasts of the first image, the second image, and the combined image according to the first embodiment.

FIG. 10 is a diagram showing contrasts of the first image, the second image, and the combined image according to the first embodiment.

FIG. 11 is a diagram showing contrasts of the first image, the second image, and the combined image according to the first embodiment.

FIG. 12 is a graph showing a spectral reflectance of paper.

FIG. 13 is a graph showing a spectral characteristic of projected light projected from a projector according to the first embodiment.

FIG. 14 is a graph showing a spectral characteristic of projected light projected from the projector according to the first embodiment.

FIG. 15 is a graph showing a spectral characteristic of projected light projected from the projector according to the first embodiment.

FIG. 16 is an xy chromaticity diagram for explaining a color gamut.

FIG. 17 is a block diagram showing a display system according to a second embodiment.

FIG. 18 is a flowchart showing a display method according to the second embodiment.

FIG. 19 is a block diagram showing a display system according to a third embodiment.

FIG. 20 is a diagram showing a display system according to a fourth embodiment.

FIG. 21 is a diagram showing a display system according to a fifth embodiment.

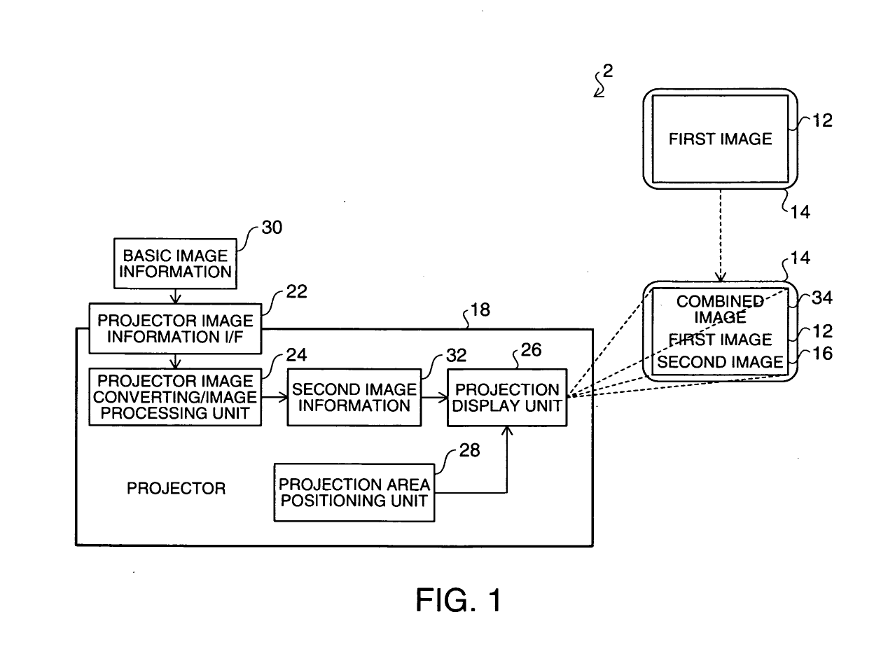

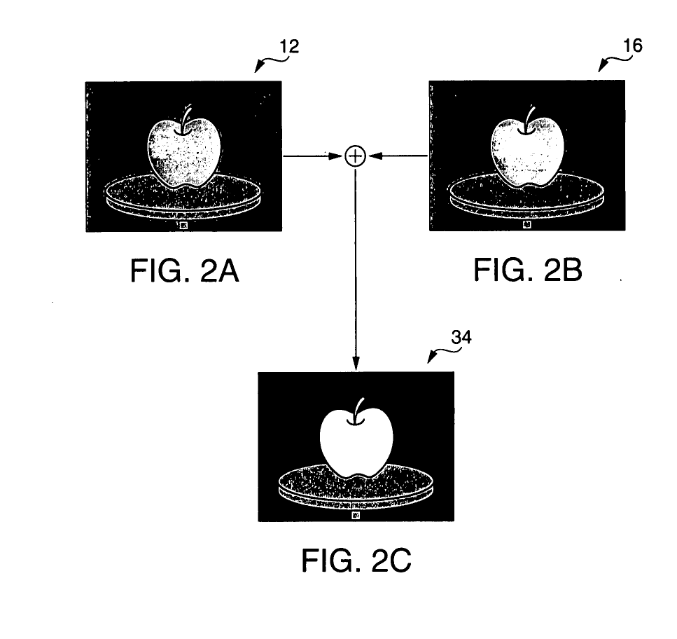

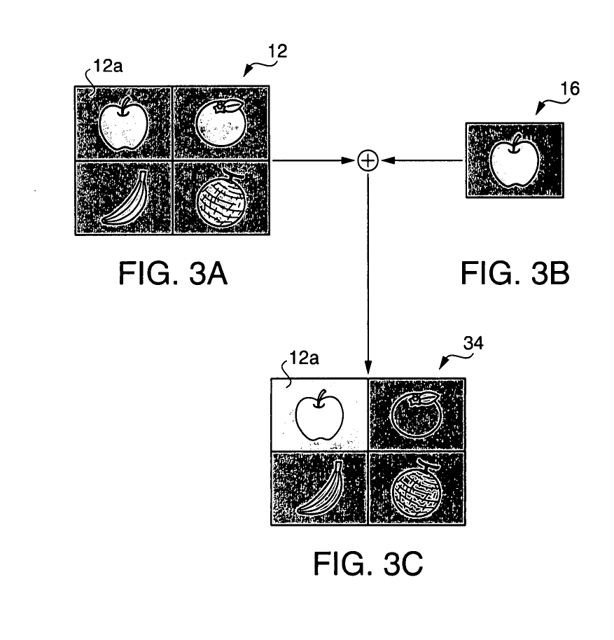

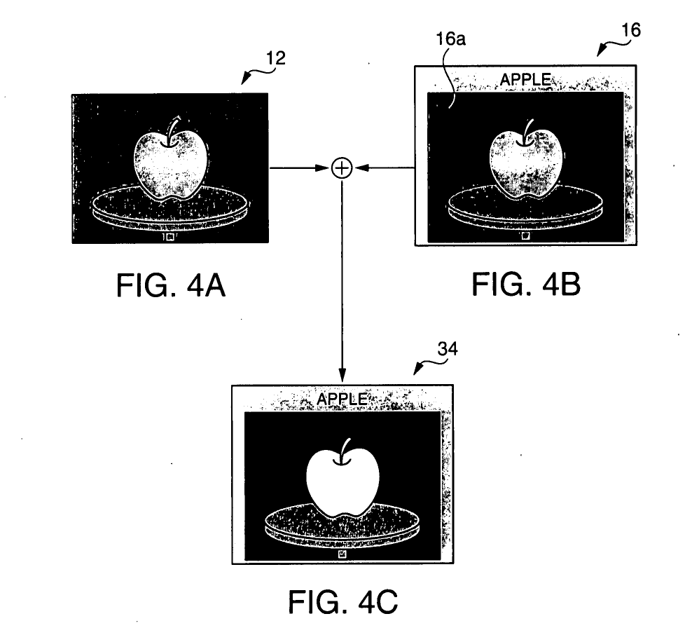

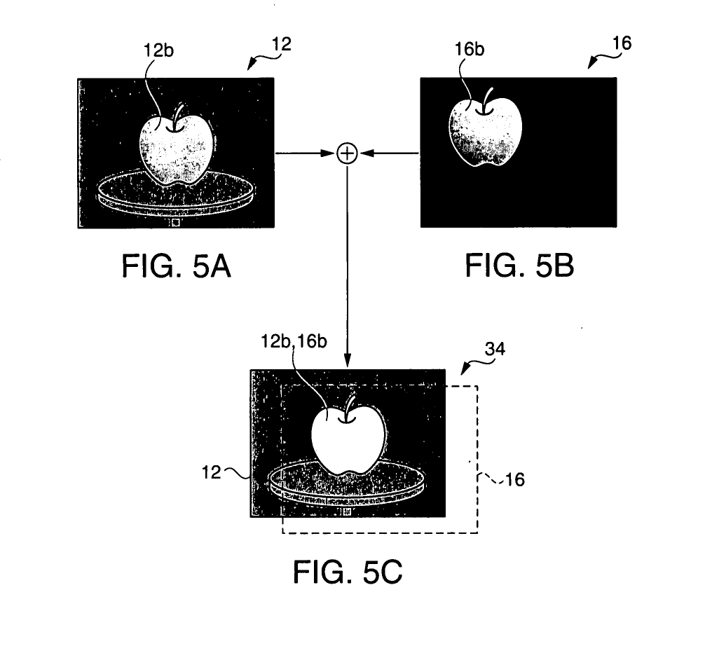

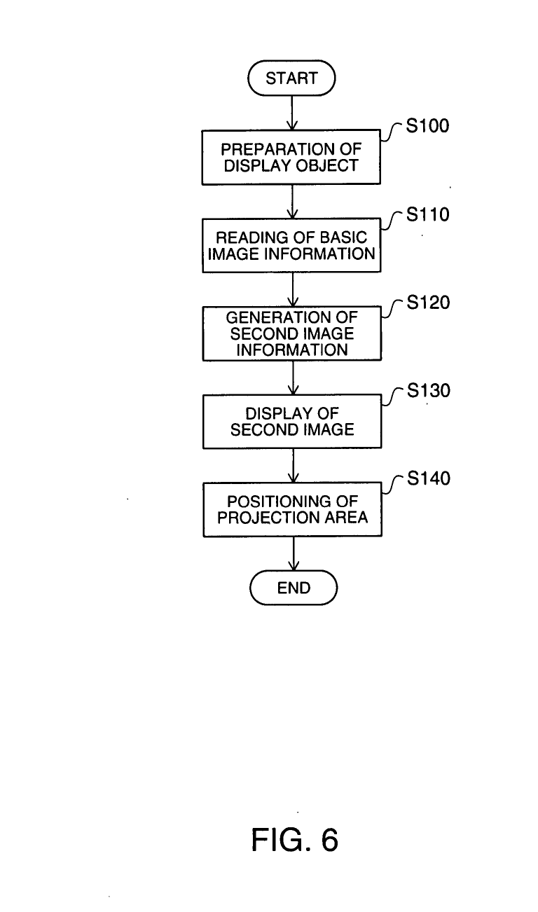

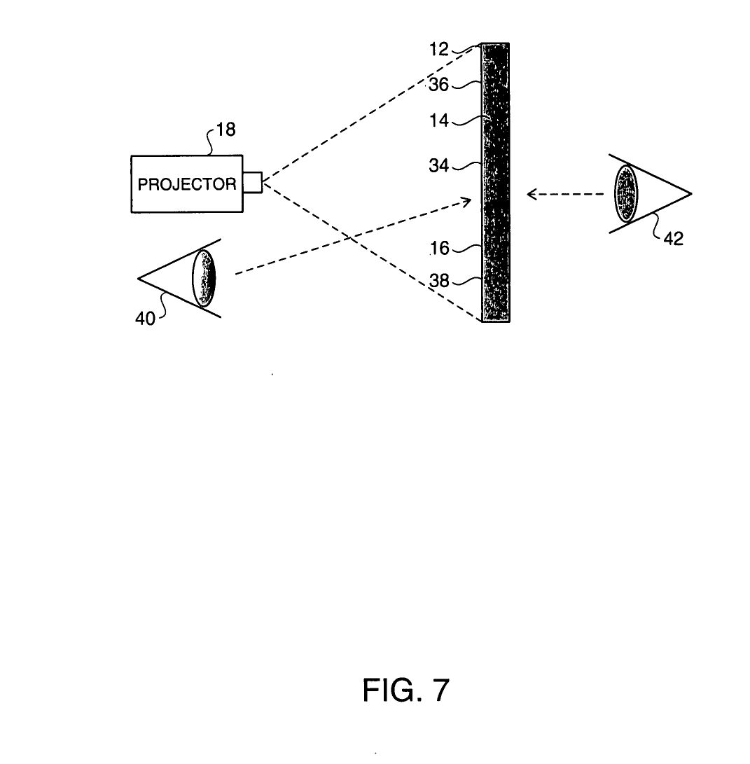

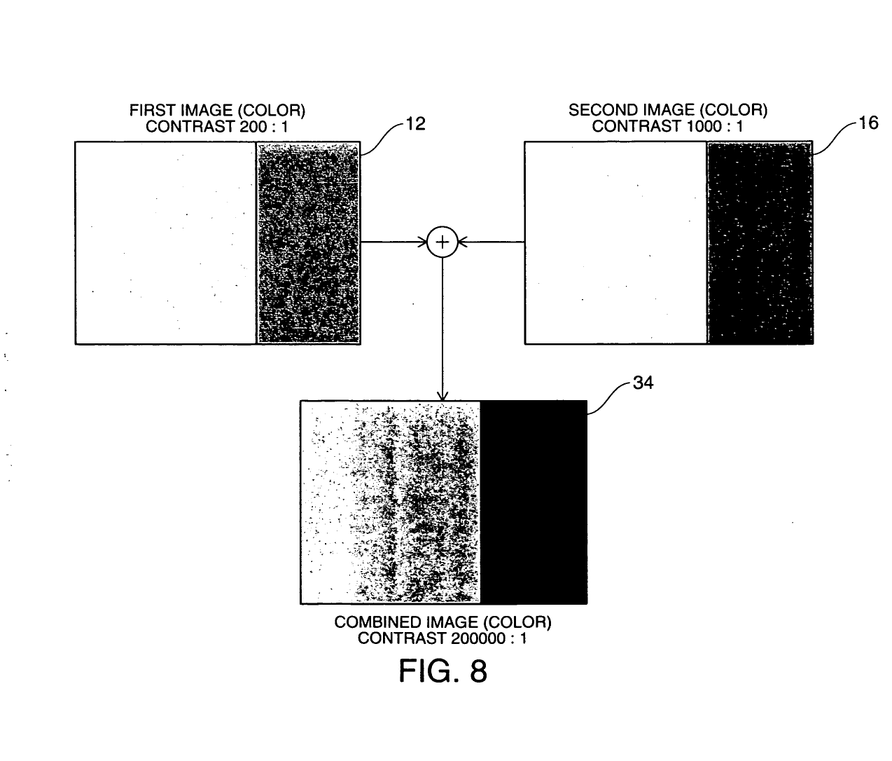

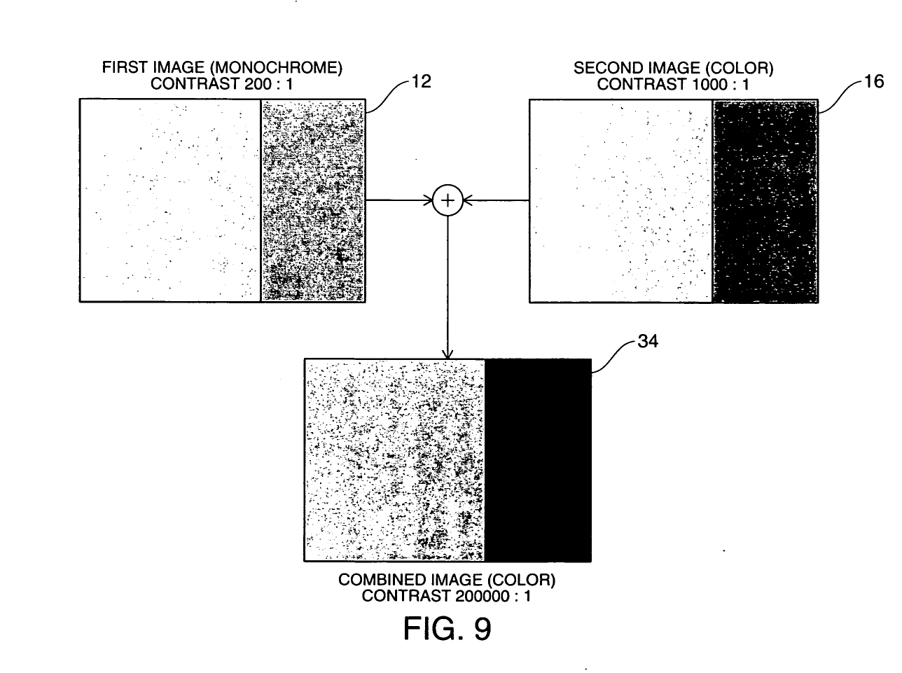

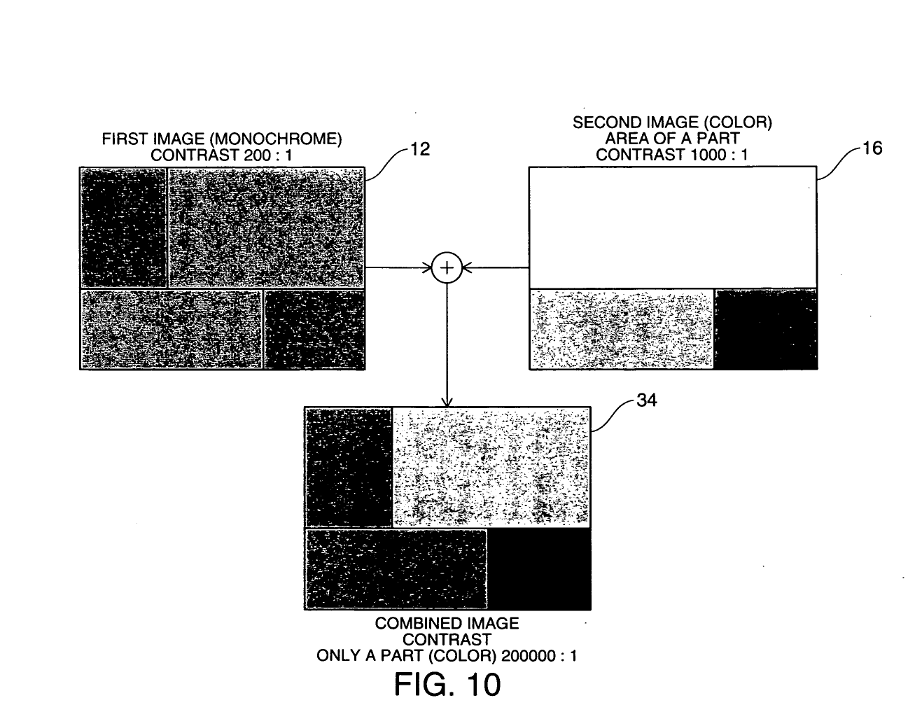

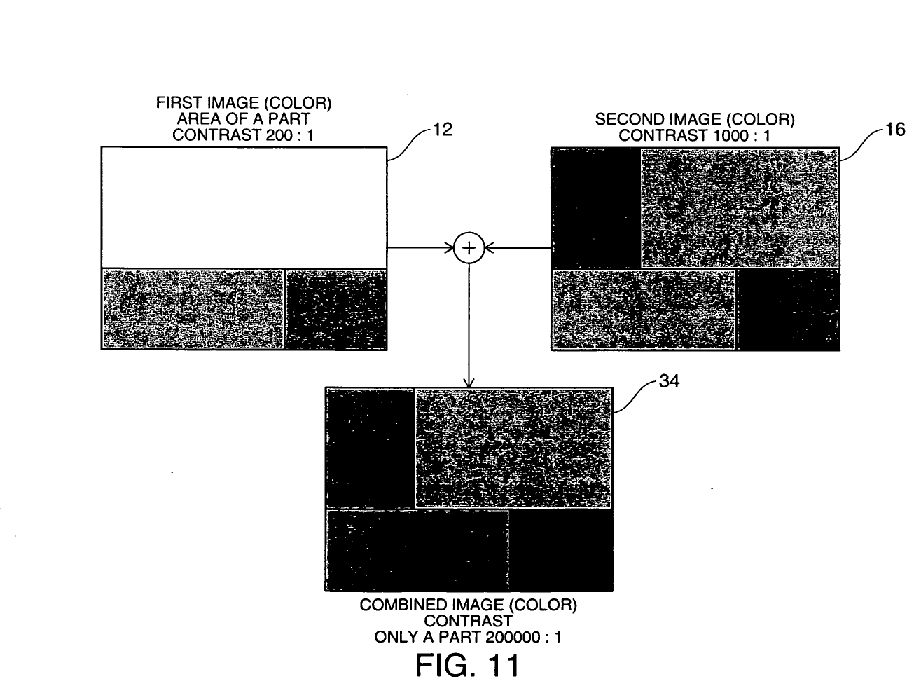

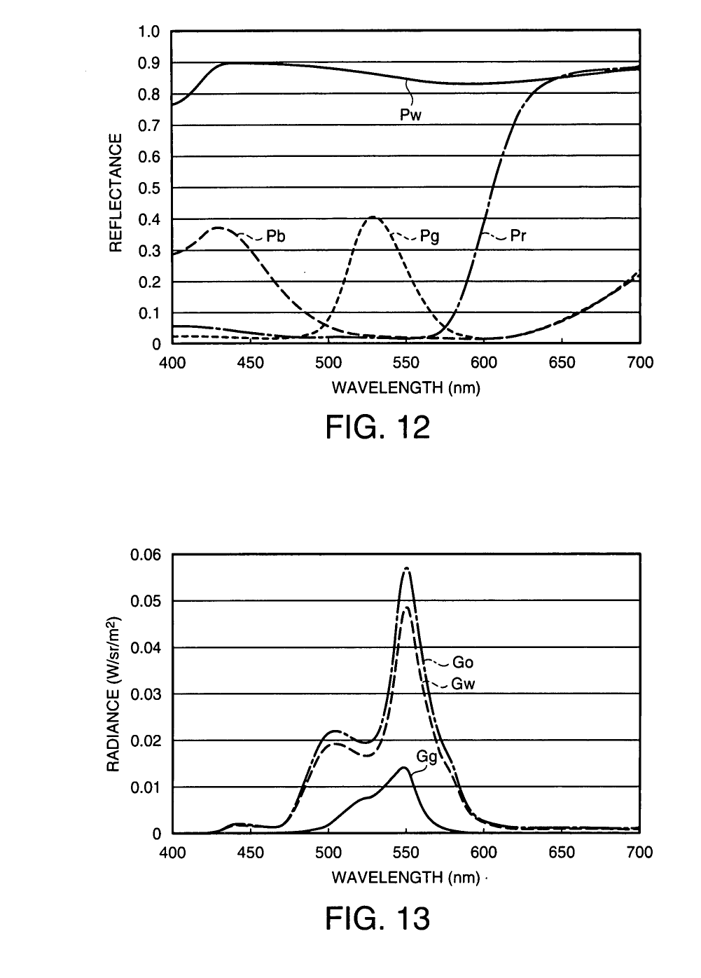

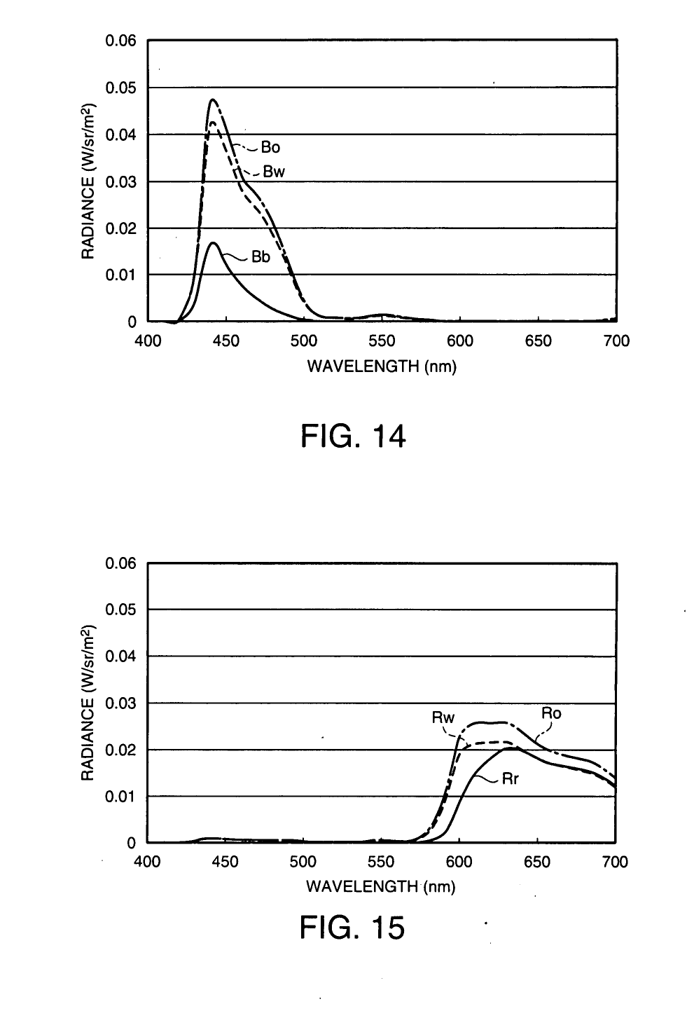

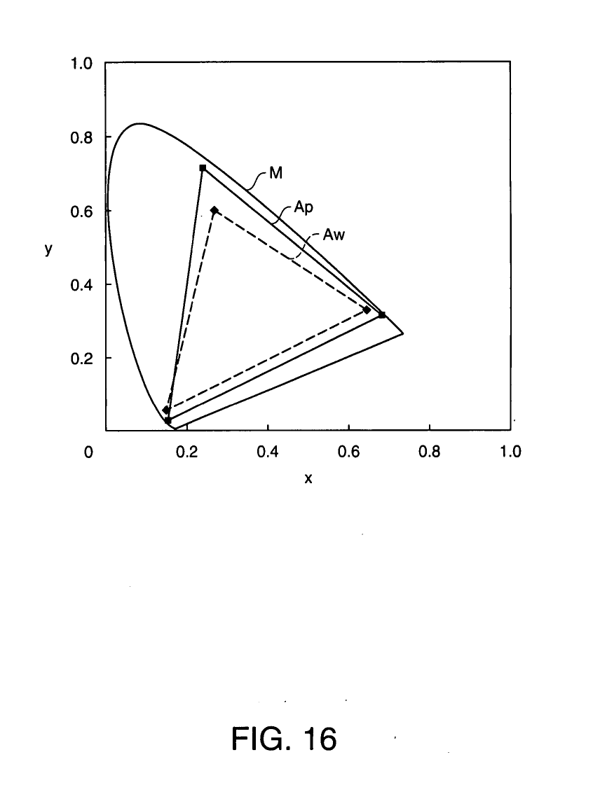

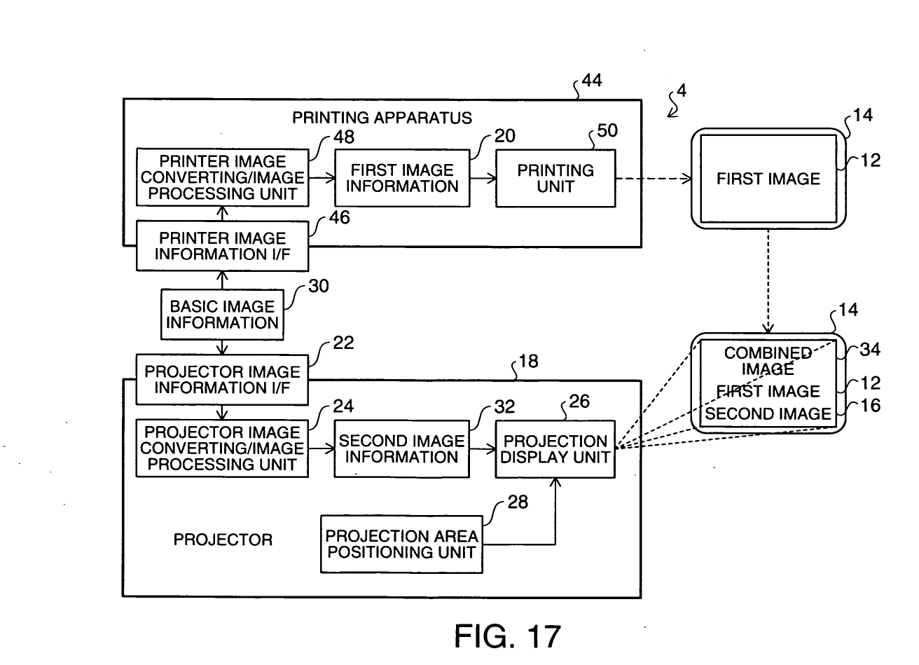

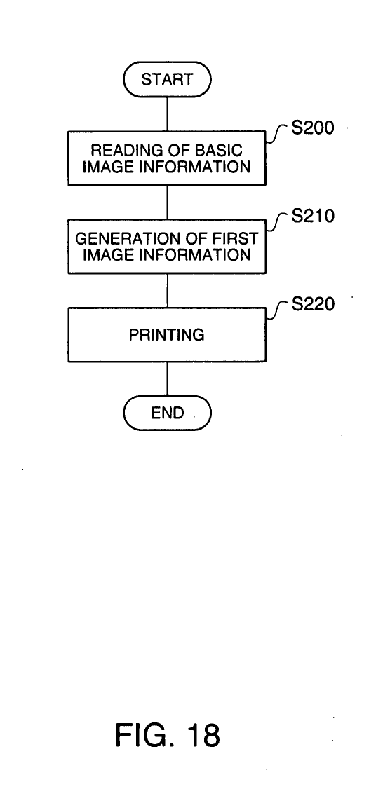

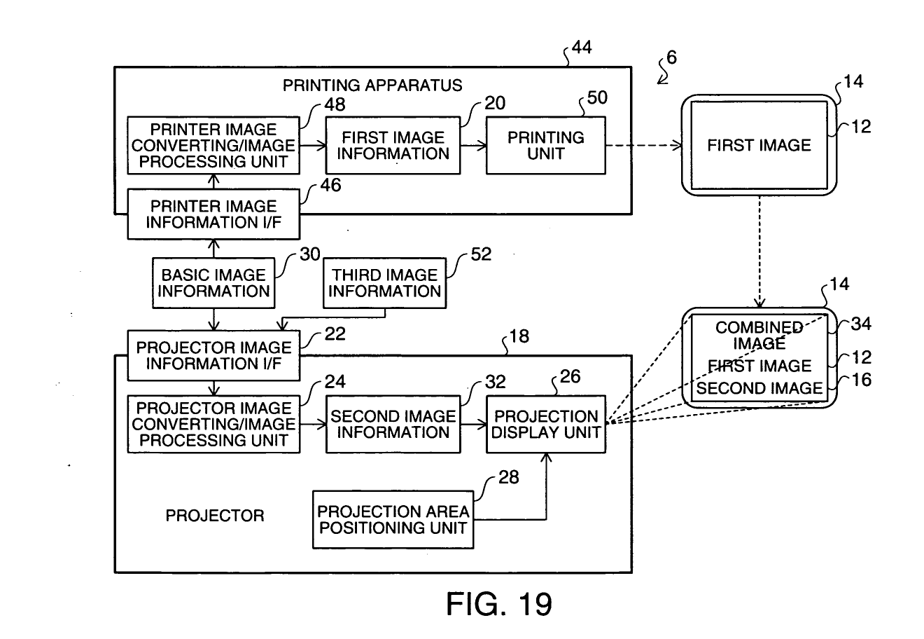

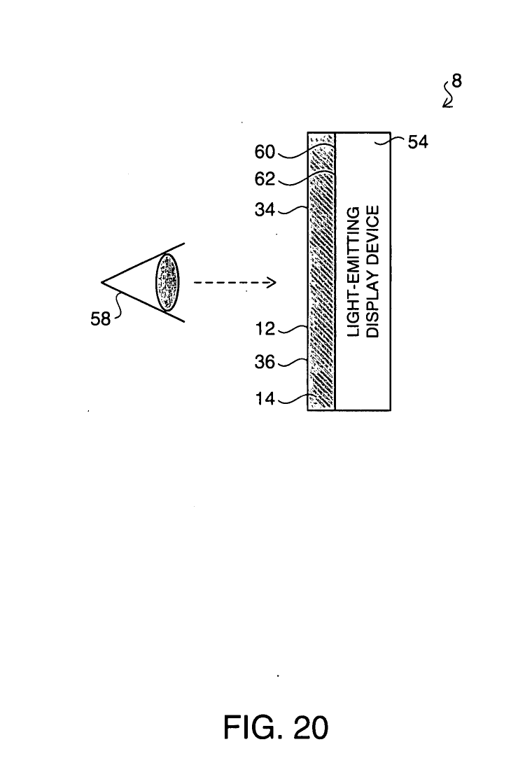

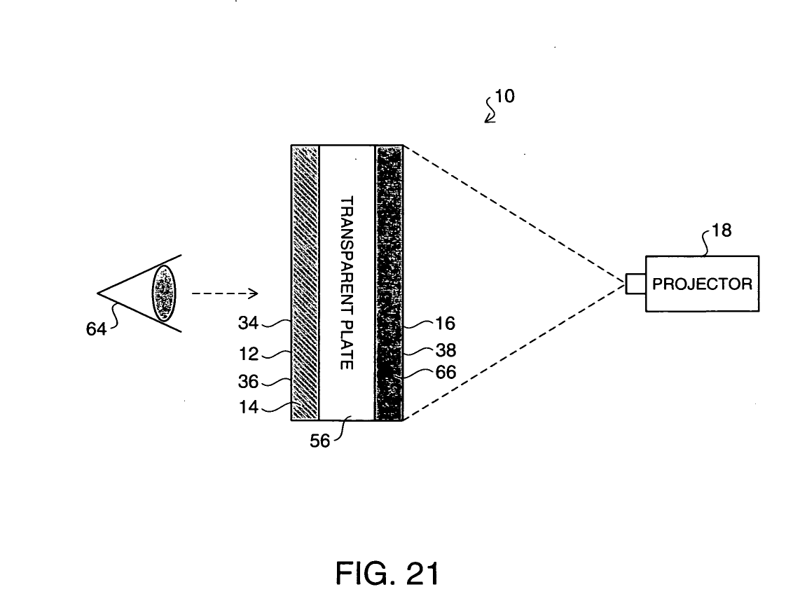

### DESCRIPTION OF REFERENCE NUMERALS AND SIGNS

2, 4, 6, 8, 10: Display systems, 12: First image, 14: Display object, 16: Second image, 18: Projector, 20: First image information, 22: Projector image information I/F, 24: Projector image converting/image processing unit, 26: Projection display unit, 28: Projection area positioning unit, 30: Basic image information, 32: Second image information, 34: Combined image, 36, 38: Surfaces, 40, 42: Eye points, 44: Printing apparatus, 46: Printer image information I/F, 48: Printer image converting/image processing unit, 50: Printing unit, 52: Third image information, 54: Light-emitting display device, 56: Transparent plate, 58: Eye point, 60: Second image, 62: Display surface, 64: Eye point, 66: Transparent/semitransparent member.

1. A display system, characterized by comprising:
a display object having a first image based on image information formed thereon;
an image display unit that displays a second image, which is generated on the basis of image information and includes an area having a gradation state substantially identical with that of an area of at least a part of the first image, to the display object; and
an image-area positioning unit for superimposing the areas having the substantially identical gradation states of the first image and the second image on each other.

2. A display system according to claim 1, characterized in that the area of the first image and the area of the second image have substantially identical coloring states.

3. A display system according to claim 1, characterized by further comprising an image forming unit that forms the first image on the display object.

4. A display system according to claim 1, characterized in that the first image and the second image are generated on the basis of common basic image information.

5. A display system according to claim 4, characterized in that the second image is generated on the basis of the basic image information and image information different from the basic image information.

6. A display system according to claim 1, characterized in that the second image is displayed on a surface having the first image of the display object formed thereon.

7. A display system according to claim 1, characterized in that the image display unit projects the second image to the display object.

8. A display system, characterized by comprising:
a display object having a first image based on image information formed thereon; and
an image display unit that displays a second image, which is generated on the basis of image information and includes an area having a gradation state substantially identical with that of an area of at least a part of the first image, to the display object such that the areas having the substantially identical gradation states overlap each other.

9-14. (canceled)

15. A display system, characterized by comprising:
a display object;
an image forming unit that forms a first image based on basic image information on the display object; and
an image display unit that displays a second image, which is generated on the basis of the basic image information and includes an area having a gradation state substantially identical with that of an area of at least a part of the first image, to the display object such that the areas having the substantially identical gradation states overlap each other.

16. A display system according to claim 15, characterized in that the area of the first image and the area of the second image have substantially identical coloring states.

17. A display system according to claim 15, characterized in that the second image is generated on the basis of the basic image information and image information different from the basic image information.

18. A display system according to claim 15, characterized in that the second image is displayed on a surface having the first image of the display object formed thereon.

19. A display system according to claim 15, characterized in that the image display unit projects the second image to the display object.

20. A display system, characterized by comprising:
a display object;
an image forming unit that forms a first image on the display object on the basis of image information; and
an image display unit that displays a second image, which is generated on the basis of image information and includes an area having a gradation state substantially identical with that of an area of at least a part of the first image, to the display object such that the areas having the substantially identical gradation states overlap each other.

21-25. (canceled)

26. A display method, characterized by comprising:
a step of displaying a second image, which is generated on the basis of image information and includes an area having a gradation state substantially identical with that of an area of at least a part of the first image, to a display object having a first image based on image information formed thereon; and
a step of performing positioning to superimpose the areas having the substantially identical gradation states of the first image and the second image on each other.

27. A display method, characterized by comprising displaying a second image, which is generated on the basis of image information and includes an area having a gradation state substantially identical with that of an area of at least a part of the first image, to a display object having a first image based on image information formed thereon such that the areas having the substantially identical gradation states overlap each other.

28. A display method according, characterized by comprising:
a step of forming a first image based on basic image information on a display object; and
a step of displaying a second image, which is generated on the basis of the basic image information and includes an area having a gradation state substantially identical with that of an area of at least a part of the first image, to the display object such that the areas having the substantially identical gradation states overlap each other.

29. A display method, characterized by comprising:
a step of forming a first image on a display object on the basis of image information; and
a step of displaying a second image, which is generated on the basis of image information and includes an area having a gradation state substantially identical with that of an area of at least a part of the first image, to the display object such that the areas having the substantially identical gradation states overlap each other.
